(19) United States
(12) Patent Application Publication
(10) Pub. No.: US 2005/0260981 A1
(43) Pub. Date: Nov. 24, 2005

(54) Method of inserting a communication module into a wireless communication system

(76) Inventor: Robert Edmund Todd, Northumberland (GB)

Correspondence Address: Jack Schwartz & Associates, Suite 1510, 1350 Broadway, New York, NY, 10018, US

(21) Appl. No.: 10/511,620

(22) PCT Filed: Apr. 25, 2003
(86) PCT No.: PCT/GB03/01766

§ 371 Date: Jul. 5, 2005

(30) Foreign Application Priority Data
May 11, 2002 (GB) 0210862.9

(51) Int. Cl. H04M 3/00

(52) U.S. Cl. 455/420

(57) ABSTRACT

A radio frequency communication system comprises a control module (1) and communications modules (2, 3) the modules communicating with each other by means of radio frequency signals. Initially, the control module (1) is allocated address number (0) and the communications modules (2, 3) are allocated address numbers (1) and (2) respectively. The system shown in FIG. (1) is set up as a loop arrangement, in which signals are transmitted from communications module (3) directly to the control module (1), so that the control module is also allocated address number (3). When a new module (4) is to be inserted into the system at the location shown in FIG. (1), the new module (4) is caused to emit a first message, in a set up mode, at low, medium and high power levels, as shown in FIG. (2). The message transmitted by the module (4) at each power level contains data identifying whether it has been transmitted at high, medium or low power level.

The present invention relates to a method of inserting a communications module into a wireless communications system.

Wireless communications systems are known which comprise at least one control module and a plurality of communications modules arranged such that the system can transmit messages either directly or indirectly between modules. In configuring the system, a decision needs to be made as to which modules communicate directly with which other modules. This decision is often made on the basis of received signal strength indication (RSSI) measurements, which measure the intensity of radio frequency radiation (i.e. based on the electric or magnetic field strength of the radio frequency radiation received at a particular receiving module). Communication links are then set up on the basis of these measurements, based on the assumption that the communication link from a particular transmitting module will be most effective with that receiving module which receives the radio frequency signal of highest intensity.

However, the existing system suffers from the drawback that the assumption that a receiving module receiving a signal of high intensity will also be able to effectively receive messages cannot always be made. For example, in urban locations where signals are reflected or obstructed by buildings, a signal of high intensity may be received, but interference effects may prevent the message carried by that signal from being decoded.

Preferred embodiments of the present invention seek to overcome the above disadvantages of the prior art.

According to the present invention, there is provided a method of inserting a communications module into a wireless communication system comprising at least one control module and a plurality of first communications modules, wherein the system is adapted to transmit messages either directly or indirectly between modules, and wherein each said first communications module is adapted to receive a wireless message and transmit said message to a further first communications module or to a said control module, and is programmed with at least one respective address identifying modules with which it communicates messages directly when in a communication mode, the method comprising:

(i) causing a second communications module, which is to be inserted into the system, to transmit a plurality of first messages in a set up mode, wherein at least two said first messages are transmitted at different power levels and contain data representing said power levels;

(ii) causing said second communications module to be installed to communicate directly, when in said communication mode, with at least one said communications module which correctly received a said first message.

By arranging the second communications module to communicate directly with a first communications module which correctly received a said first message, this provides the advantage of not relying on the assumption that the most reliable communications link is with the first module receiving the signal of highest intensity. This in turn provides the advantage that the system is more reliable than the prior art.

The method may further comprise the step of causing said second communications module to be installed to communicate directly, when in said communication mode, with at least two said communications modules which correctly received a said first message.

The method may further comprise the step of causing said second communications module to communicate directly with the pair of first communications modules which directly received a said first message most reliably.

The method may further comprise the step of allocating points to each said first message received by said first communications modules, wherein first messages received at lower power levels are allocated larger numbers of points, and said second communications module is caused to communicate directly, when in said communication mode, with the pair of modules allocated the largest total number of points for first messages received from said second communications module.

This provides the advantage of setting up communications links, in the case of the second communications module being adapted to communication with two first communications modules, on the basis of the best overall receipt of first messages by a pair of first communications modules, and thus avoids the situation in which the second communications module is caused to communicate with a first communications module which receives messages well and a first communications module which receives messages badly.

The second communications module may be caused to be installed by means of a second message, from at least one said control module updating the address of a said first module which correctly received a said first message.

The method may further comprise the step of causing said second module to communicate directly with the first communications module which correctly received a said first message transmitted at lowest power level.

The method may further comprise the step of causing said second communications module to communicate with the first communications module which correctly received a said first signal at the largest number of different power levels.

The first messages may be transmitted at at least three different power levels.

The method may further comprise the step of setting the power level of transmission from said second communications module in said communication mode to a predetermined first communications module in response to the power level of a said first message received by said predetermined first communications module.

This provides the advantage of enabling the power of transmission of a particular link between the second communications module and a predetermined first communications module to be adjusted according to the reliability of receipt of the message by the first communications module. This provides the further advantage of minimising power waste.

A preferred embodiment of the invention will now be described, by way of example only and not in any limitative sense, with reference to the accompanying drawings, in which:

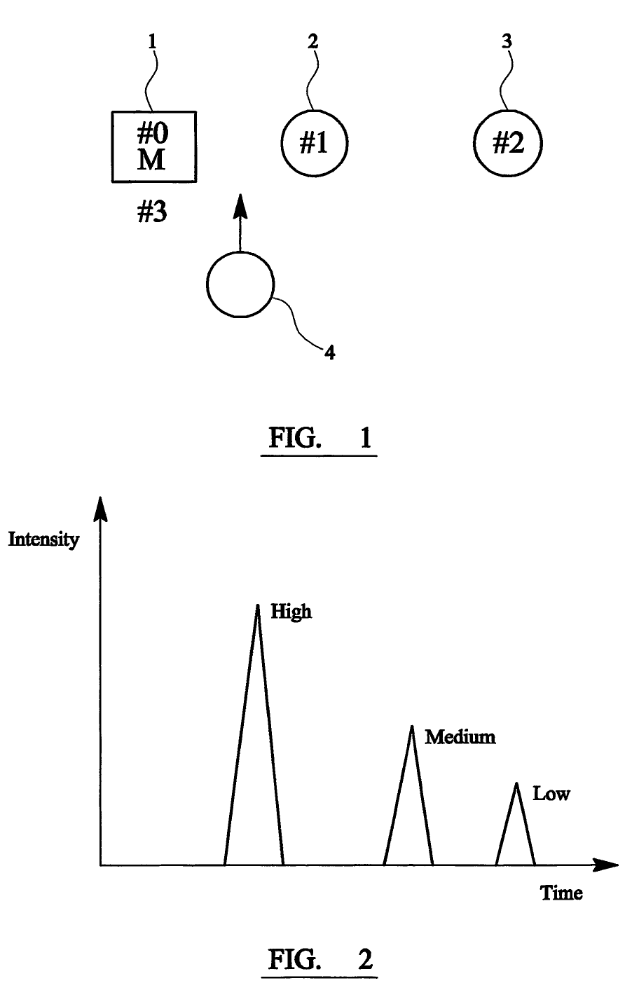

FIG. 1 is a schematic representation of a wireless communication system to which a communications module is to be added; and

FIG. 2 is a representation of first message transmitted power level versus time of the unit to be added to the system of FIG. 1.

Referring to FIG. 1, a radio frequency communication system comprises a control module 1 and communications modules 2, 3 the modules communicating with each other by means of radio frequency signals. Initially, the control module 1 is allocated address number 0 and the communications modules 2, 3 are allocated address numbers 1 and 2 respectively. The system shown in FIG. 1 is set up as a loop arrangement, in which signals are transmitted from communications module 3 directly to the control module 1, so that the control module is also allocated address number 3. However, it will be understood that the present invention is also applicable to communications systems set up in a linear chain arrangement.

When a new module 4 is to be inserted into the system at the location shown in FIG. 1, the new module 4 is caused to emit a first message, in a set up mode, at low, medium and high power levels, as shown in FIG. 2. The message transmitted by the module 4 at each power level contains data identifying whether it has been transmitted at high, medium or low power level.

The existing modules 1, 2, 3 which correctly receive the message from the new module 4 are identified, and the system makes a decision as to which pair of modules 1, 2 or 3 should communicate directly with new module 4 on the basis of which pair of modules most reliably decoded the transmitted messages. For example, points are allocated such that three points represent a module correctly receiving a message at low power level, two points the message correctly received at medium power level, and one point represent a message correctly received at high power level. The system is then arranged to install the new module 4 into the system such that it communicates directly, when in the communications mode, with the pair of existing modules 1, 2 or 3 having the highest total number of points allocated for a message from the new module 4.

For example, if existing unit 1 receives a signal from the new unit at medium and high power levels, the module 2 receives a signal from module 4 at all three power levels, and the module 3 receives the message from module 4 at high power level only, the modules 1,2 and 3 are allocated 3, 6 and 1 points respectively. The adjacent pair of modules 1, 2 or 3 having the highest number of points is the pair consisting of modules 1 and 2, and the new module 4 is therefore installed in the loop between modules 1 and 2, i.e. to communicate directly with those two modules. As a result, new module 4 is allocated address number 1, and the addresses of existing modules 2 and 3 are incremented by one to address numbers 2 and 3 respectively, and the second address in control module 1 is incremented to 4.

It will be appreciated by persons skilled in the art that the above embodiment has been described by way of example only and not in any limitative sense, and that various alternations and modifications are possible without departure from the scope of the invention as defined by the appended claims.

1. A method of inserting a communications module into a wireless communication system comprising at least one control module and a plurality of first communications modules, wherein the system is adapted to transmit messages either directly or indirectly between modules, and wherein each said first communications adapted to receive a wireless message and transmit said message to a further first communications module or to a said control module, and is programmed with at least one respective address identifying modules with which it communicates messages directly when in a communication mode, the method comprising:
(i) causing a second communications module, which is to be inserted into the system, to transmit a plurality of first messages in a set up mode, wherein at least two said first messages are transmitted at different power levels and contain data representing said power levels;
(ii) causing said second communications module to be installed to communicate directly, when in said communication mode, with at least one said communications module which correctly received a said first message.

2. A method according to claim 1, further comprising the step of causing said communications module to be installed to communicate directly, when in said communication mode, with at least two said communications modules which correctly received a said first message.

3. A method according to claim 2, further comprising the step of causing said second communications module to communicate directly with the pair of first communications modules which directly received a said first message most reliably.

4. A method according to claim 3, further comprising the step of allocating points to each said first message received by said first communications modules, wherein first messages received at lower power levels are allocated larger numbers of points, and said second communications module is caused to communicate directly, when in said communication mode, with the pair of modules allocated the largest total number of points for first messages received from said second communications module.

5. A method according to claim 1, wherein said second communications module is caused to be installed by means of a second message, from at least one said control module updating the address of a said first module which correctly received a said first message.

6. A method according to claim 1, further comprising the step of causing said second module to communicate directly with the first communications module which correctly received a said first message transmitted at lowest power level.

7. A method according to claim 1, further comprising the step of causing said second communications module to communicate with the first communications module which correctly received a said first signal at the largest number of different power levels.

8. A method according to claim 1, wherein the first messages may be transmitted at least three different power levels.

9. A method according to claim 1, further comprising the step of setting the power level of transmission from said second communications module in said communication mode to a predetermined first communications module in response to the power level of a said first message received by said predetermined first communications module.

10. (canceled)
